(19) United States
(12) Patent Application Publication
(10) Pub. No.: US 2024/0046181 A1
(43) Pub. Date: Feb. 8, 2024

(54) INTELLIGENT TRAINING COURSE RECOMMENDATIONS BASED ON EMPLOYEE ATTRITION RISK

(71) Applicant: Praisidio Inc., Menlo Park, CA (US)

(72) Inventors: Vahed Qazvinian, San Francisco, CA (US); Kenneth Richard Klein, Atherton, CA (US); Sergii Denysiuk, Wroclaw (PL); Rafael Jacinto, British Columbia (CA); Gabriel Micko, Budapest (HU)

(21) Appl. No.: 17/881,989

(22) Filed: Aug. 5, 2022

(51) Int. Cl. G06Q 10/06; G06Q 50/20

(52) U.S. Cl. CPC G06Q 10/0635; G06Q 50/2057

(57) ABSTRACT

The systems and methods described herein provide for predictions of employee attrition within an enterprise. In one embodiment, the system connects to one or more internal data sources within the enterprise and one or more external data sources outside of the enterprise, receiving internal feed data from the internal data sources and external feed data from the external data sources, the internal feed data relating to a number of employees. The system then determines, based on at least the internal feed data, a number of attrition risk factors for the employees; receives LMS data corresponding to training courses being offered; generates one or more training course recommendations for the employees; and presents the training course recommendations to one or more client devices.

### FIELD

The presently described systems and methods relate generally to human capital management, and more particularly, to providing intelligent training course recommendations based on employee attrition risk.

### BACKGROUND

Human capital management is a set of practices within an organization which are concerned with the recruitment, management, development, and optimization of employees as intangible, valuable assets within the organization. One of the largest components of human capital management is employee retention. In particular, voluntary employee attrition is a strain on enterprise resources, and can have a significant material impact on operations, culture, product delivery, and costs.

Traditionally, employee attrition mitigation has involved manual approaches. Often, spreadsheets are manually populated with information and edited, which is time consuming, inefficient, and prone to human error. More recently, human capital management (“HCM”) systems have emerged as software solutions. Such systems may be able to collect certain sets of data relating to employee attrition and perform heuristics analysis on the data. This may be used to provide reports on employee attrition, for example.

Once reports and analytical data is acquired, it can be used to provide companies, including executives, managers and/or human resources (HR) teams, with information related to risk of attrition for particular employees. For example, such data may be able to identify individual employees who are at risk of experiencing “burnout” in their role. Perhaps they are struggling with time management, and as a result feel as though there is not enough time in the workday to fulfill their work obligations; or perhaps they feel as if the compensation they receive for the position is lower than they are capable of receiving at other companies.

While HCM systems may be able to identify the risk of attrition for employees, they are not currently able to address the underlying causes of that risk of attrition in an effective way. A company may know that a particular employee is at risk of burnout, but may not have any concrete steps to correct the problem. In the case of the employee who struggles with time management, it is not immediately obvious how to help that employee improve their time management skills. Thus, identification is only the first step in addressing employee attrition, but there is still no good automated or intelligent solution for the next step, which is related to addressing and correcting the reasons for an employee being at high risk for leaving.

Thus, there is a need in the field of human capital management to create a new and useful system and method for providing intelligent training course recommendations based on employee attrition risk. The source of the problem, as discovered by the inventors, is a lack of relevant, quantifiable, and reliable data which can be received from multiple current sources and analyzed in a dynamic fashion.

The systems and methods described herein provide for predictions of employee attrition within an enterprise. In one embodiment, the system connects to one or more internal data sources within the enterprise and one or more external data sources outside of the enterprise, receiving internal feed data from the internal data sources and external feed data from the external data sources, the internal feed data relating to a number of employees. The system then determines, based on at least the internal feed data, a number of attrition risk factors for the employees; receives learning management system (“LMS”) data corresponding to training courses being offered; generates one or more training course recommendations for the employees based on at least the LMS data; and presents the training course recommendations to one or more client devices.

The features and components of these embodiments will be described in further detail in the description which follows. Additional features and advantages will also be set forth in the description which follows, and in part will be implicit from the description, or may be learned by the practice of the embodiments.

### BRIEF DESCRIPTION OF THE DRAWINGS

FIG. 1A is a diagram illustrating an exemplary environment in which some embodiments may operate.

FIG. 1B is a diagram illustrating an exemplary computer system that may execute instructions to perform some of the methods therein.

FIG. 2 is a flow chart illustrating an exemplary method that may be performed in accordance with some embodiments.

FIG. 3 is a flow chart illustrating an example embodiment of a method for providing a platform for prediction employee attrition and generating explanations for the predictions, in accordance with some aspects of the systems and methods herein.

FIG. 4 is a flow chart illustrating an example embodiment of a method for providing a platform for predicting employee attrition and generating explanations for the predictions, in accordance with some aspects of the systems and methods herein.

FIG. 5A is a diagram illustrating an example embodiment of a portion of a user interface for selecting a retention path for one or more employees with attrition risk factors, in accordance with some aspects of the systems and methods herein.

FIG. 5B is a diagram illustrating an example embodiment of a portion of a user interface for reviewing a list of employees with attrition risk factors, in accordance with some aspects of the systems and methods herein.

FIG. 5C is a diagram illustrating an example embodiment of a portion of a user interface for reviewing a list of employees with attrition risk factors by job title, in accordance with some aspects of the systems and methods herein.

FIG. 5D is a diagram illustrating an example embodiment of a portion of a user interface for making one or more selections from a list of recommended retention tasks, in accordance with some aspects of the systems and methods herein.

FIG. 5E is a diagram illustrating an example embodiment of a portion of a user interface for creating one or more retention tasks for one or more employees with attrition risk factors, in accordance with some aspects of the systems and methods herein.

FIG. 6A is a diagram illustrating an example embodiment of a portion of a user interface for tracking analytical data related to retention tasks, in accordance with some aspects of the systems and methods herein.

FIG. 6B is a diagram illustrating an example embodiment of a portion of a user interface for tracking the impact of retention tasks for employees with attrition risk factors, in accordance with some aspects of the systems and methods herein.

FIG. 6C is a diagram illustrating an employee profile with attrition risk factors presented.

FIG. 7 is a diagram illustrating an exemplary computer that may perform processing in some embodiments.

### DETAILED DESCRIPTION

In this specification, reference is made in detail to specific examples of the systems and methods. Some of the examples or their aspects are illustrated in the drawings.

For clarity in explanation, the systems and methods herein have been described with reference to specific examples, however it should be understood that the systems and methods herein are not limited to the described examples. On the contrary, the systems and methods described herein cover alternatives, modifications, and equivalents as may be included within their respective scopes as defined by any patent claims. The following examples of the systems and methods are set forth without any loss of generality to, and without imposing limitations on, the claimed systems and methods. In the following description, specific details are set forth in order to provide a thorough understanding of the systems and methods. The systems and methods may be practiced without some or all of these specific details. In addition, well known features may not have been described in detail to avoid unnecessarily obscuring the systems and methods.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

The following generally relates to the prediction and mitigation of voluntary employee attrition. The collection and normalization of daily activity feeds from multiple sources, representing the data as a time-evolving graph, may be used in the prediction of employee risk and graph evolution overtime.

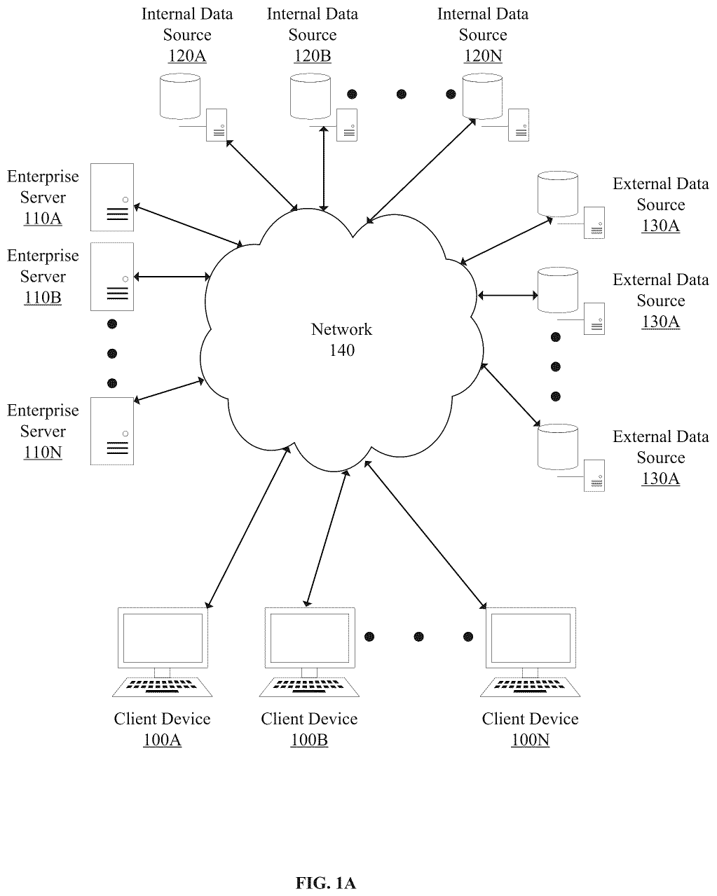

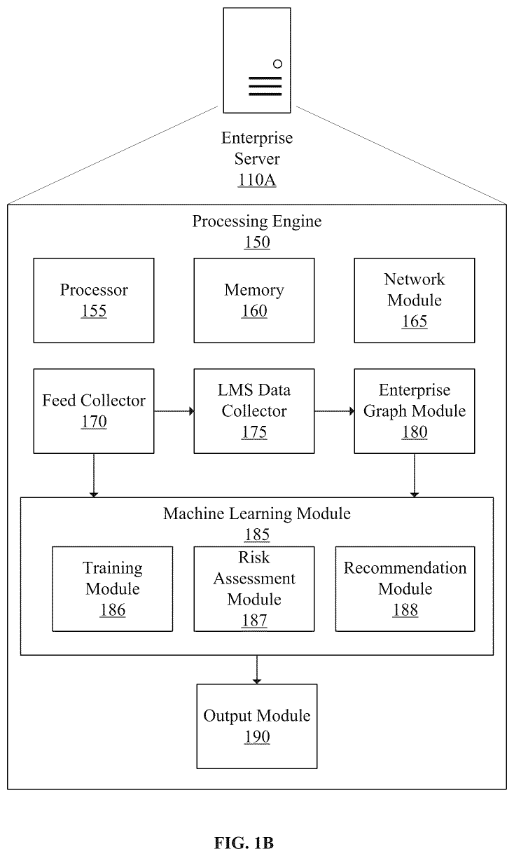

FIG. 1A is a diagram illustrating an exemplary environment in which some embodiments may operate. The diagram shows an example of an employee attrition prediction, explanation and mitigation platform, in accordance with some embodiments. The example shown includes client device 100A-100N, enterprise server 110A-1 ION, internal data source 120A-120N, external data source 130A-130N and network 140. Enterprise server 110A-110N may be an example of, or include aspects of, the corresponding element or elements described with reference to FIG. 1B.

Client devices 100A-100N are any devices that send and receive information to and from the network 140 for purposes of operating a standalone application or web-based application in a browser. In varying embodiments, client devices 100A-100N may be personal computers, personal digital assistants (PDAs), tablet computing devices, laptop computers, smart phones, e-readers, virtual reality or augmented devices, wearables, or any other suitable systems capable of operating a standalone application or web-based application in a browser.

Enterprise server 110A-110N may be any computing device capable of executing the operation of processing engine 150. Enterprise server 110A-110N may be connected through a network 140 to client devices 100A-100N, internal data sources 120A-120N and external data sources 130A-130N.

Internal data sources 120A-120N are data sources relating to data and information kept within an organization and generally not shared outside of the organization. In some embodiments, data sources and their associated feeds can fall under a number of categories. In some embodiments, such categories can include, e.g., human resources (HR), Communications, Compensation, Calendar and Task Tracking. In some embodiments, HR feeds capture employee history within the company e.g. job title change, cash compensation change, manager and location change, project history, and other associated HR data. In some embodiments, communications feeds capture communications metadata relating to which entities are communicating with whom, how often the communication occurs, and/or what the communication entails. In some embodiments, communications metadata can include, e.g., memberships in mailing lists, metadata relating to instant messaging and other conversational platforms and channels, as well as frequency and time of communication between entities. In some embodiments, communications feeds neither capture the subject line nor the content of emails or instant messages. In some embodiments, Calendar feeds capture metadata related to scheduled events and meetings, e.g., group meetings and manager one-on-one meetings. This feed helps the system understand latent networks (friends and collaborations) within the organization. In some embodiments, the system may track equity compensation through Compensation feeds. In some embodiments, task tracking feeds may collect and analyze work activity of entities by connecting to task tracking tools. In some embodiments, internal data sources may be related to one or more LMSes, and internal data feeds may include LMS data associated with the one or more LMSes about the enterprise and/or one or more employees within the enterprise.

External data sources 130A-130N are data sources relating to data and information outside of an organization. In some embodiments, external data sources additionally or alternatively relate to information which is outside of the organization's ability to directly control or influence. In some embodiments, one or more external data sources may be accessed, viewed, or shared as a common source available across all customers or a subset of customers. In varying embodiments, external data can relate to sectors of industry, locations, economic or financial trends, global or regional variables, or any other suitable external data outside of an organization. In some embodiments, external data sources may include, e.g., feeds of census data such as rent, public competitor feeds such as a competitor's stock price and public sentiment indices such as employer ratings and reviews from current and former employees posted on anonymous review platforms. For example, external data sources with respect to a particular organization or entity within the organization can include or relate to the average rent of San Francisco, recent stock market crashes, an uptrend or downtrend in that organization's industry, or employee attrition rates across different cities or countries. In some embodiments, external data sources may be related to one or more LMSes, and external data feeds may include LMS data associated with the one or more LMSes about the enterprise, one or more employees within the enterprise, and/or non-employees or other LMS users not associated with or employed by the enterprise (e.g., anonymized and/or aggregated user data relating to users who have enrolled in and/or completed a training course, where the user data may relate to, e.g., performance assessments, attendance records, profile data, demographic data, or any other data which may be relevant or suitable.

Some embodiments of the attrition prediction and mitigation system reduce voluntary employee attrition within an enterprise through the application of artificial intelligence, machine learning, deep learning, neural networks or combinations thereof. The system may also provide a proactive and real-time risk assessment, as well as explanations and suggested actions to mitigate attrition risk. The system may gather data passively, obviating the requirement for constant human input.

Thus, the systems and methods herein provide an end-to-end software system that may collect and normalize daily activity data feeds from multiple sources, represent the data as a time-evolving graph, and predict employee risk and graph evolution over time. The system may comprise modules to collect feed data, build enterprise graphs, generate risk assessments and provide explanations of attrition risks to a user as well as suggest actions targeted to a specific employee's circumstances. The circumstances of the employee's attrition risk may be modeled in an enterprise graph and used by a machine learning module to learn which actions are effective at mitigating attrition for employees with similar graphs.

FIG. 1B is a diagram illustrating an exemplary computer system that may execute instructions to perform some of the methods therein. The diagram shows an example of an attrition prediction, explanation and mitigation processing engine. Processing engine 150 may be an example of, or include aspects of, the corresponding element or elements described with reference to FIG. 1A. In some embodiments, processing engine 150 is a component or system on enterprise server 110A. In other embodiments, processing engine 150 may be a component or system on client device 100A-100N, or may be a component or system on peripherals or third-party devices. Processing engine 150 may comprise hardware or software or both.

Processing engine 150 may include processor 155, memory 160, network module 165, feed collector 170, LMS data collector module 175, enterprise graph module 180, machine learning module 185, training module 186, risk assessment module 187, explanation module 188 and output module 190.

A processor 155 may include an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 155 may be configured to operate a memory array using a memory controller. In other cases, a memory controller may be integrated into processor 155. The processor 155 may be configured to execute computer-readable instructions stored in a memory to perform various functions related to employee attrition prediction and mitigation, enterprise graph generation, risk assessment as well as the generation of explanations and action suggestion for specific entities such as employees.

Memory 160 may include random access memory (RAM), read-only memory (ROM), or a hard disk. The memory 160 may be solid state or a hard disk drive, and may store computer-readable, computer-executable software including instructions that, when executed, cause a processor to perform various functions described herein. In some cases, the memory 160 may contain, among other things, a BIOS which may control basic hardware or software operation such as the interaction with peripheral components or devices. In some cases, a memory controller may operate memory cells as described herein.

Network module 165 functions to transmit and receive data and receive data from other computing systems via a network. In some embodiments, the network module 165 may enable transmitting and receiving data from the Internet. Data received by the network module 165 may be used by the other modules. The modules may transmit data through the network module 165.

Feed collector 170 functions to collect data and metadata from internal and external data feeds. Data feeds may fall under a number of categories and capture data and metadata relating to information which may be pertinent to employee attrition. Feed collector may be automatically run at user specified intervals, or in response to notifications from feed sources that indicate updated information is available. Thus, the data may be passively gathered for use in employee attrition risk predictions.

In some embodiments, an optional normalization module functions to receive the collected data and metadata from feed collector 170. In some embodiments, the collected data and metadata may be pruned of unnecessary data by the normalization module. In some embodiments, the normalization module may also remove Personal Identifiable Information (“PII”) from the data in an anonymization step. The data and metadata may then be formatted and normalized into data within a single format. Normalized data may then be passed to the enterprise graph module 180 for further processing.

LMS data collector 175 functions to receive one or more pieces of LMS data corresponding to training courses being offered. At least a subset of the LMS data relates to the effectiveness of the training courses. In some embodiments, the system receives the LMS data from one or more LMSes. In some embodiments, the system connects to an LMS, then receives LMS data from the LMS upon connecting. For example, the system may need to connect to the LMS by logging in to an established account on the LMS associated with the enterprise or one or more employees within the enterprise, or otherwise authenticating an identity within the LMS associated with the enterprise or one or more employees within the enterprise. Upon logging in or authenticating, data relating to the enterprise or the one or more employees associated with the identity or account may become accessible and retrievable. In some embodiments, the system makes use of one or more APIs for one or more LMSes in order to automate retrieval of LMS data in a consistent, periodic or semi-periodic, repeated, and/or ongoing basis. In some embodiments, the system retrieves the data from one or more flat files associated with one or more LMSes.

In some embodiments, at least a subset of the LMS data is associated with historical data of employees who have attended one or more of the training courses being offered. In some embodiments, at least a subset of the LMS data relates to how effective the training courses being offered have been with respect to employees who have attended the training courses. In some embodiments, at least a subset of the LMS data includes historical data relating to non-employees who have attended training courses. In some embodiments, the LMS data may include one or more assessments of employees' performance, attendance, or other factors within one or more training courses they have enrolled in and/or completed, or are currently enrolled in. In some embodiments, one or more assessments can be an effectiveness assessment for the employee after the employee has completed one or more training courses. In some embodiments, such an effectiveness assessment may be based on internal and/or external data from the internal and/or external data sources.

Enterprise graph module 180 functions to generate time-evolving graphs from the collected and normalized daily activity feeds from a plurality of sources. Enterprise graph module periodically builds enterprise graphs of entities and their relationships from the collected and normalized data. The enterprise graphs represent the enterprise at a point in time. These graphs function as modelled snapshots of the connections present between entities within the enterprise. In some embodiments, these snapshots evolve across multiple graphs over time. In some embodiments, the enterprise graphs may be stored for use in predicting the evolution of the graph at a future time. In some embodiments, in the enterprise graphs, employees may be connected to their managers and peers via work relationships. Employees may also be connected through work on specific products and/or projects. In some embodiments, employee connections to compensation, salary and/or bonuses in the enterprise graph may also be used to partly help determine attrition risk. Each node of the enterprise graph represents an employee or enterprise entity. In some embodiments, these nodes include information relating to that employee or enterprise entity, such as, e.g., location, compensation, and projects. Employee nodes in the graph have relationships with nodes representing team members, managers, projects, products, and compensation.

Machine learning module 185 functions to perform various machine learning, deep learning, and/or artificial intelligence tasks within the system. In some embodiments, machine learning module 185 may include one or more of training module 186, risk assessment module 187 and/or recommendation module 188. The machine learning module 185 may comprise decision trees such as, e.g., classification trees, regression trees, boosted trees, bootstrap aggregated decision trees, random forests, rotation forests or a combination thereof. Additionally or alternatively, machine learning module 185 may comprise neural networks (NN) such as, artificial neural networks (ANN), autoencoders, probabilistic neural networks (PNN), time delay neural networks (TDNN), convolutional neural networks (CNN), deep stacking networks (DSN), radial basis function networks (RBFN), general regression neural networks (GRNN), deep belief networks (DBN), deep neural networks (DNN), deep reinforcement learning (DRL), recurrent neural networks (RNN), fully recurrent neural networks (FRNN), Hopfield networks, Boltzmann machines, deep Boltzmann machines, self-organizing maps (SOM), learning vector quantizations (LVQ), simple recurrent networks (SRN), reservoir computing, echo state networks (ESN), long short-term memory networks (LSTM), bi-directional RNNs, hierarchical RNNs, stochastic neural networks, genetic scale models, committee of machines (CoM), associative neural networks (ASNN), instantaneously trained neural networks (ITNN), spiking neural networks (SNN), regulatory feedback networks, neocognitron networks, compound hierarchical-deep models, deep predictive coding networks (DPCN), multilayer kernel machines (MKM), cascade correlation networks (CCN), neuro-fuzzy networks, compositional pattern-producing networks, one-shot associative memory models, hierarchical temporal memory (HTM) models, holographic associative memory (HAM), neural Turing machines, or any combination thereof. In other embodiments, rather than the machine learning module 185 comprising NNs, it may instead comprise one or more statistical models. In some embodiments, at least one of the statistical models may be a generative statistical model, such as, e.g., Latent Dirichlet Allocation (LDA). Any other suitable neural networks, machine learning techniques, statistical models, or other models may be contemplated.

A neural network is a hardware or a software component that includes a number of connected nodes (a.k.a., artificial neurons), which may be seen as loosely corresponding to the neurons in a human brain. Each connection, or edge, may transmit a signal from one node to another (like the physical synapses in a brain). When a node receives a signal, it can process the signal and then transmit the processed signal to other connected nodes. In some embodiments, the signals between nodes comprise real numbers, and the output of each node may be computed by a function of the sum of its inputs. Each node and edge may be associated with one or more node weights that determine how the signal is processed and transmitted.

During the training process, training module 186 may adjust these weights to improve the accuracy of the result (e.g., by minimizing a loss function which corresponds in some way to the difference between the current result and the target result). The weight of an edge may increase or decrease the strength of the signal transmitted between nodes. In some embodiments, nodes may have a threshold below which a signal is not transmitted at all. The nodes may also be aggregated into layers. Different layers may perform different transformations on their inputs. In some embodiments, the initial layer is the input layer and the last layer is the output layer. In some cases, signals may traverse certain layers multiple times.

Risk assessment module 187 functions to model the changes in the enterprise graph over time. In some embodiments, risk assessment module 187 may employ a machine learning model, such as a deep learning model, deep belief network, artificial neural network, or any of the aforementioned neural networks. In some embodiments, current graphs may be compared with representations of historical data to detect, assess, prioritize, alert, explain, and suggest timely actions with workflows to reduce voluntary employee attrition. In some embodiments, connections between entity nodes may be weighted based on strength of the ties between the entities. In some embodiments, stronger ties between nodes indicate a lower attrition risk, and weaker ties or newly broken ties indicate an elevated attrition risk. In some embodiments, observations of changes to the strength of ties between entity nodes as well as broken ties between entity nodes are made over time. These observations may provide insight into an employee's attrition risk at the current time or at a future time by predicting the attrition risk based on data trends.

In some embodiments, machine learning module 185 and/or risk assessment module 187 may additionally or alternatively combine external feeds with the enterprise graph sequences to build the input used by the machine learning module 185 and/or risk assessment module 187. External feeds relate to information and data which are external to the organization, and which are not directly controllable or manipulable by the organization. In some embodiments, at least a subset of the information and data from external feeds are shared among and/or accessible by multiple organizations within the system. In varying embodiments, external feeds may comprise census data such as rent, public competitor feeds such as a competitor's stock price and public sentiment indices such as employer ratings and reviews from current and former employees posted on anonymous review platforms. In some embodiments, risk assessment module 187 may observe changes in enterprise relationships, consisting of many weak signals over time, and benefit from external feeds to create a strong risk signal which affects employee risk prioritization. In some embodiments, the risk assessment module 187 may combine a series of sequence inputs (pay change, team change, etc.) with a number of categorical inputs (such as current public sentiment, industry, employee gender, etc.) in the generation of the attrition risk model. In some embodiments, the attrition risk model may be used to generate specific predictions in terms of which employee is at an increased attrition risk as well as when the attrition risk will occur. In some embodiments, predictions may be given priority when attrition risk reaches a specified threshold. In some embodiments, the threshold may be a predetermined threshold and/or a dynamically calculated threshold relative to the attrition risk levels of other employees.

In some embodiments, risk assessment module 187 may also generate intermediate attrition risk models for groups of entities within an enterprise environment. In varying embodiments, these groups may be clustered together based on, e.g., gender, project assignments, department, work group, office location, supervisor, and/or any other suitable risk factor or sets of risk factors associated with employee entities. Inputs to the model that may be result in higher risk factors may include, e.g., an employee's bonus, equity, salary, merit based raise, relative salary verses other employees, time since last raise or promotion, and/or any other suitable inputs. In some embodiments, attrition risk models for the intermediate clusters of employees (such as, e.g., women, high potential employees, and/or employees on critical projects) may be useful in retaining employees that are integral to high revenue projects and to the diversity of the workplace. In some embodiments, attrition risk models may be used to identify systemic problems in a work environment, such as sexism and racism. A disproportionately higher attrition probability for a minority group may bring to light underlying problems with projects, or managers that should be remedied to minimize the employer's liability.

In some embodiments, an optional explanation module functions to provide actionable, human-understandable explanations for attrition risk. In some embodiments, the explanations may be ranked or sorted by priority of the attrition risk. In some embodiments, the explanation module provides the attrition risk model with input examples based on training data. In some embodiments, the explanations are first extracted in terms of high-dimensional features, and then projected on to a low-dimensional space categorized into groups such as, e.g., connection, contribution, career, and context. In varying embodiments, a connection group represents the relationships within the company including, e.g., relationships with managers, the leadership team, peers, and friends. The contribution group represents how an employee is valued by the company in quantitative terms such as, e.g., salary, bonus, promotion, reviews, and ranking. The career risk group identifies employees who are showing symptoms of likely attrition, such as, e.g., symptoms of stagnating, being overstimulated, or being burned out. Employees who are stimulated at the right amount and are experiencing job growth may signify a lower career risk. The context group may generally be composed of external signals such as, e.g., reputation, cultural health, and life stage events such as a having a baby.

In some embodiments, the explanation module may also generate entity “stories” or time-based narratives that visually represent an employee's timeline and lifecycle. These stories may display important milestone achievements or major changes across multiple snapshots of an employee's graphs. In some embodiments, significant changes between one timestamp to the next, with respect to the nodes of the employee graph, may trigger an alert notifying a user of the system that an employee is at risk for voluntary attrition. In some embodiments, the explanation module 188 determines which employees are at the highest attrition risk and prioritizes the attrition mitigation efforts to these employees. In some embodiments, the explanation module 188 may also determine which risk factors are of the highest importance by analyzing the risk factors of previous employees that separated from employment at the organization. Previous employees may have multiple risk factors that result in voluntary attrition, and a union set of all the risk factors responsible for the employee attritions may be used to calculate the voluntary attrition risk of the specific employee being analyzed. If any of the most common risks occur for an individual employee, the employee may be flagged as being of high risk for attrition.

In some embodiments, the magnitude of changes to a graph between snapshots may not be used. In some embodiments, meaningful changes to the graph may be small, but unexpected or of high importance. Minor risks and minor changes may be part of the graph, or filtered and/or ignored if they do not meet or exceed a threshold of importance or relevance. Gaps in minor risks may be important. This may depend on when and how often they occur. The gaps in minor risks may impact the risk factor by a larger amount than what the minor risk would normally impart. Minor risks that appear frequently may not be a sign of high overall risk. However, minor risks that are not expected or do not normally appear may be a sign of a significant change. Minor risks that appear at a particular frequency may also be significant if there is a large change in that frequency between snapshots. The change may be to a more frequent appearance or less frequent appearance. In some embodiments, the explanation module additionally or alternatively generates a summary of risky events and non-risky events that occur between snapshots of an employee graph.

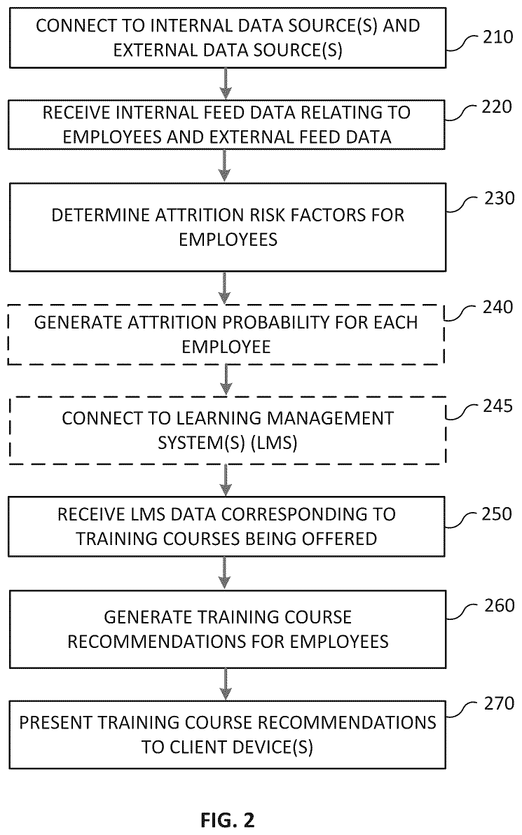

Recommendation module 188 functions to generate training course recommendations for one or more employees within an enterprise, as will be described further with respect to FIG. 2 below.

Output module 190 functions to present training course recommendations to one or more client devices, as will be described further with respect to FIG. 2 below.

In some embodiments, output module 190 further functions to generate one or more user interfaces for the display and visual representation of employee attrition risk. In some embodiments, output module 190 provides one or more dashboards which allow a user to select information to be displayed and/or to interact with data visualizations. In some embodiments, the dashboards import risk assessments from the risk assessment module 187 and explanation models from the explanation module 188, and periodically show a new list of employees (or groups of employees who are grouped by, e.g. location, cohort, gender, etc.) who are at high risk of attrition. In some embodiments, the dashboards provide employers with options to provide feedback, take action, and/or monitor progress on their actions to mitigate employee attrition risk. The targeted actions and their effects (e.g., pay raise, project change, etc.) may then be used as inputs within a closed loop feed by the machine learning module 185, risk assessment module 187 and/or the optional explanation module.

In some embodiments, the system may, via the dashboard or some other interface, collect information from one or more users about whether they found a recommendation or multiple recommendations useful. This may take the form of prompting the user for feedback or providing one or more methods for the user to input feedback. In various embodiments, such explicit and/or manually provided feedback from the user is used by the system to train and improve the functioning and accuracy of the current recommendation model, or to train a new and improved recommendation model over previous models. In some embodiments, if the recommendation was considered helpful or effective by the user, then the system adjusts the ML model and/or statistical model which generates the recommendations, or trains a new ML and/or statistical model for generating recommendations. In such a way, in some embodiments, the outcomes and efficacy of courses as reported by users manually as well as by collecting internal data about employee metrics, performance, and other suitable information can be enable the system to generate better recommendations over time.

In some embodiments, at least one input to such a model incorporating a feedback loop for improving recommendations is the explicit feedback from users. In some embodiments, data regarding outcomes is collected or received from such users after a certain interval of time has passed, such as, e.g., 6 months after the course began or 6 months after the course was completed. Internal data, such as, e.g., whether there were any changes to attrition rate, employee's growth along one or more metrics, employee recognition, and/or other suitable data may be used as input to the model for this feedback loop as well. In some embodiments, an input to the model for this feedback loop is the change over the interval of time in one or more risk factors of the individual who is being recommended with something. In some embodiments, the model is updated periodically, such as once a quarter or once every 6 months. During this period of time, the system collects data, such that by the end of the period, the system has collected a table of data showing how the metrics and/or risk factors have changed since the course was taken, among potentially other data. This data is used to train a new model.

FIG. 2 is a flow chart illustrating an exemplary method that may be performed in accordance with some embodiments. The flow chart shows an example of a process for providing intelligent training course recommendations based on employee attrition risk within an enterprise environment. In some examples, these operations may be performed by a system including a processor executing a set of codes to control functional elements of an apparatus. Additionally or alternatively, the processes may be performed using special-purpose hardware. Generally, these operations may be performed in accordance with some aspects of the systems and methods herein. For example, the operations may be composed of various substeps, or may be performed in conjunction with other operations described herein.

At step 210, the system connects to internal and external data sources. In some embodiments, the operations of this step may refer to, or be performed by, a client device or enterprise server as described with reference to FIG. 1A or modules with processing engine 150 as described with reference to FIG. 1B. For example, processing engine 150 may reside on enterprise server 110A. In some embodiments, network module 165 may be used by processing engine 150 to communicate with internal data sources 120A-120N and external data sources 130A-130N via network 140.

At step 220, the system receives internal and external feed data. The internal feed data relates to a number of employees. In some embodiments, the operations of this step may refer to, or be performed by, a feed collector 170 as described with reference to FIG. 1B.

In some embodiments, after step 220, the system converts the plurality of internal feed data into normalized feed data within a single format. In some cases, the operations of this step may refer to, or be performed by, an optional normalization module as described with reference to FIG. 1B.

In some embodiments, the system generates a plurality of enterprise graphs based on the normalized feed data, wherein each enterprise graph represents relationships between entities. In some cases, the operations of this step may refer to, or be performed by, an enterprise graph module 180 as described with reference to FIG. 1B.

In some embodiments, the system generates a risk assessment model related to changes in the enterprise graphs over time. In some cases, the operations of this step may refer to, or be performed by, a risk assessment module 187 as described with reference to FIG. 1B.

At step 230, the system determines attrition risk factors for the employees. The system makes this determination based on at least the internal feed data. In some embodiments, the system may also make this determination based on external feed data and/or LMS data. In some embodiments, the attrition risk factors are selected from a prespecified list of potential attrition risk factors. Thus, a list of risk factors may already be present, and specific risk factors from the list may be selected as appropriate for employees based on the data and how it may be associated with attrition based on various risk factors. In some embodiments, the same risk factors appear for all employees, including, for example, the number of one-on-one manager meetings, internal compensation ratio, external compensation ratio, number of projects, and time in role. In some embodiments, for each risk factor that is determined, an associated risk factor value is determined as well. In various embodiments, a risk factor value may be a binary value (e.g., a 0 or a 1, true or false, or other binary value), a numerical value, a percentage, or any other relevant value. In various embodiments, attrition risk factors may be determined in any of a number of ways. In some embodiments, one or more artificial intelligence (“AI”) or machine learning (“ML”) techniques may be used to determine attrition risk factors. For example, an ML model may be trained to predict one or more attrition risk factors for an employee based on internal, external, and/or LMS data.

In some embodiments, at optional step 240, the system generates an attrition probability for at least a subset of the employees based on the determined attrition risk factors of each employee. In some embodiments, the attrition probabilities are adjusted with respect to the external feed data. In some cases, the operations of this step may refer to, or be performed by, machine learning module 185, risk assessment module 187, an optional explanation module, and/or output module 190 as described with reference to FIG. 1B.

In some embodiments, at optional step 245, the system connects to one or more LMSes. In various embodiments, the system may connect with an LMS through any relevant way that a computer system may connect with an LMS to receive data. For example, in some embodiments, the system may connect to one or more LMSes via API calls to request and retrieve LMS data. In some embodiments, the system performs a sign-in process with a user account associated with the LMS, including authentication procedures that the LMS requires. In some embodiments, one or more secure sign-on procedures may be performed.

At step 250, the system receives LMS data corresponding to training courses being offered by the one or more LMSes. In various embodiments, the system may request and retrieve LMS data from databases via API calls, may retrieve data from one or more web sites, may periodically retrieve data transmitted from LMS server(s) to the computer, or any other relevant way of retrieving LMS data.

At step 260, the system generates training course recommendations for the employees.

In some embodiments, the system generates training course recommendations via a training recommendation module. In some embodiments, the training recommendation module is based on artificial intelligence (“AI”) techniques, such as machine learning (“ML”) techniques. In other embodiments, the training recommendation model is based on one or more statistical models and/or techniques. If a particular system or task is limited to a certain demographic (e.g., software engineers within an enterprise organization), such AI, ML, or statistical models or techniques may be unnecessary. However, as the system scales to encompass many different roles within a particular organization, or many organizations, such AI, ML, or statistical models or techniques may become necessary for generating training recommendations. For example, if the training courses needed to be generated apply only to software engineers, then a single set of domain knowledge may be applied. However, if training course recommendations must be made for, e.g., attorneys, salespeople, software engineers, and account executives, then many sets of domain knowledge may be necessary to be applied for training a model to generate training course recommendations.

In some embodiments, the system must overlay data and/or metadata, sourced from one or more of the external data sources, internal data sources, and LMS data, then model that data in order to provide training course recommendations. In some embodiments, such data may include, for example, human resources (“HR”) data, calendar data, recommendations from one or more sources, effectiveness assessments of one or more employees or non-employees, and more.

At step 270, the system presents the generated training course recommendations to one or more client devices. In some embodiments, a manager of an employee may be associated with one of the client devices. In some embodiments, the employee themselves may be associated with a client devices. Other relevant parties, such as an executive of the organization, may be associated with client devices.

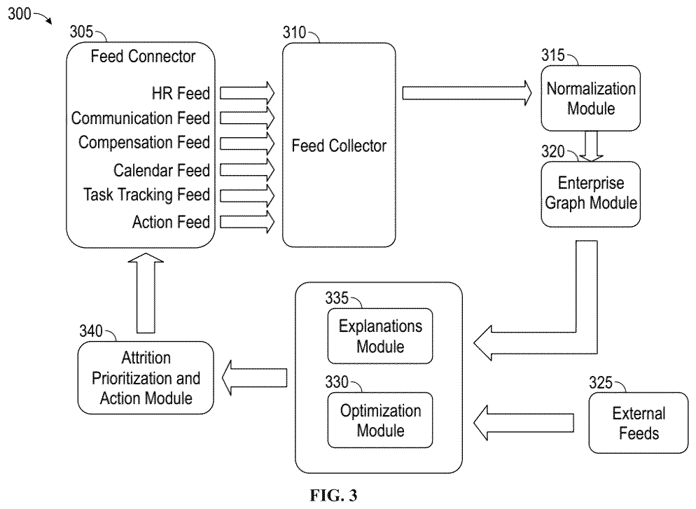

FIG. 3 is a flow chart illustrating an example embodiment of a method for providing a platform for predicting employee attrition and generating explanations for the predictions, in accordance with some aspects of the systems and methods herein. The attrition prioritization platform 300 may include feed connector 305, feed collector 310, optional normalization module, enterprise graph module 320, external feeds 325, optimization module 330, optional explanation module, and attrition prioritization and action module 340.

Feed connector 305 may connect to internal feed sources such as 110A-110N as well as attrition prioritization and action module 340 data from optimization module 330 and/or explanation module 335. Internal data feeds help refine risk at a granular employee level. Data feeds may fall under a number of categories such as, e.g., HR, Communications, Compensation, Calendar and Task Tracking, as previously described. Feed connector 305 may periodically connect to internal feeds and the output of the machine learning module 185, risk assessment module 187 and/or explanation module 188. In varying embodiments, the connections may be initiated automatically, at user specified intervals, or in response to notifications from feed sources that indicate updated information is available.

In some embodiments, feed collector 310 may be run periodically to aggregate data from feeds connected to feed connector 305. The newly aggregated data may then be combined and passed to the normalization module 315.

Normalization module 315 functions to remove any unnecessary parts from the aggregated feed data and convert/format the aggregated data into a single normalized format. In some embodiments, normalization module 315 may additionally strip Personal Identifiable Information (PII) from the feed data to preserve employee anonymity. In some embodiments, internal feed data may be normalized within an organization. In some embodiments, events, such as which employee is performing a task at a particular time (e.g., via timestamps), and relationships between employees and entities within the company, may be normalized prior to generation of the enterprise graphs. Anonymized and normalized data is then passed to the enterprise graph module 320.

Enterprise graph module 320 functions to read the normalized data passed from the normalization module and build a graph that represents the enterprise entity relationship in graph format. In some embodiments, enterprise graph module 320 can be configured to generate a graph on a predefined periodic or semi-periodic basis, such as, e.g., on a daily, weekly, or monthly basis. The system may maintain a list of historical graphs for each enterprise entity.

External feeds 325 relate to information and data which are external to the organization, and which are not directly controllable or manipulable by the organization. In some embodiments, at least a subset of the information and data from external feeds are shared among and/or accessible by multiple organizations within the system. In varying embodiments, the external feeds 325 may comprise census data such as rent, public competitor feeds such as a competitor's stock price and public sentiment indices such as employer ratings and reviews from current and former employee posted on anonymous review platforms. In some embodiments, the external feeds 325 may be incorporated into the enterprise graph sequence, creating a strong risk signal to affect employee risk prioritization. In some embodiments, the combined external feeds 325 and enterprise graph sequences may then be input to the machine learning models, optimization module 330 and explanation module 335.

In some embodiments, the external feeds 325, may be injected into the risk assessment model or one or more of risk factors, risk factor values, and/or attrition probabilities generated by the machine learning module, optimization module 330 or explanation module 335. The risk factors, risk factor values, and/or attrition probabilities may take into account external feeds 325 that represent various external factors such as, e.g., positive sentiment, comparisons between companies, models of sectors of industry, locations, stock market performance (e.g., crashes or recessions), layoffs, job market statistics, any other suitable external factors or external inputs, or any combination thereof. In some embodiments, the external feeds are used to calibrate the risk factors and/or risk factor values of the entire organization or a subset of the organization. In some embodiments, different attrition profiles may be used in different situations. Such profiles may include profiles for specific cities, countries or industries.

Optimization module 330 functions to receive the combined external feeds 325 and enterprise graph sequences and observe the changes in enterprise relationships, consisting of many weak signals, over time. The optimization module may combine a series of sequence inputs (pay change, team change, etc.) with a number of categorical inputs (such as current public sentiment, industry, employee gender, etc.) to generate an attrition risk model.

Explanation module 335 functions to functions to provide actionable, human-understandable explanations for attrition risk. In some embodiments, the explanations may be ranked or sorted by priority of the attrition risk. In some embodiments, explanation module 188 provides the attrition risk model with input examples based on training data. Further aspects of explanations are described above. In some embodiments, the explanation module 335 may provide actionable explanation and the associated priority of each explanation. In some embodiments, the explanation module 335 may additionally provide a detailed reason for the attrition.

Attrition prioritization and action module 340 functions to provide prioritized attrition and action information. In some embodiments, attrition prioritization and action module 340 may periodically show a new list of employees (or groups of employees by location, cohort, gender, etc.) who are at high risk of attrition. In some embodiments, the employer may be given the functionality to provide feedback, take actions, and monitor progress on their actions to mitigate employee attrition risk. In some embodiments, the targeted actions and their effects (e.g., pay raise, project change, etc.) may then be used as inputs to a closed loop feed by the feed connector 305, optimization module 330 and/or explanation module 335.

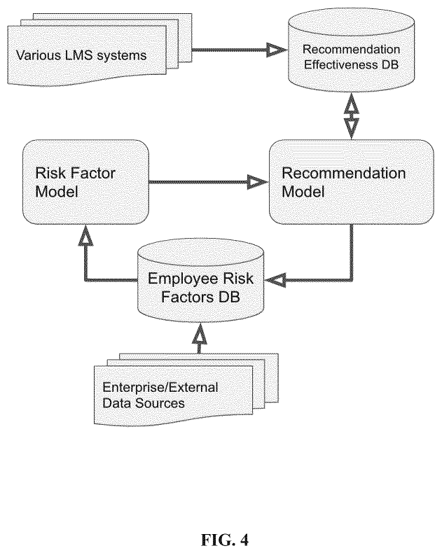

FIG. 4 is a flow chart illustrating an example embodiment of a method for providing a platform for predicting employee attrition and generating explanations for the predictions, in accordance with some aspects of the systems and methods herein.

In the illustrated flow chart, enterprise (i.e., internal) data sources and/or external data sources are used as data feeds for providing data to an employee risk factors database. The employee risk factors database includes a number of employees, each associated with one or more risk factors and associated risk factor values. The database is updated over time based on a risk factor model. Various LMS systems provide LMS data to a recommendation effectiveness database, which sends effectiveness data to a recommendation model which is trained to generate training course recommendations for employees. The recommendation model uses data from the risk factor model, and provides data to the employee risk factors database.

The illustrated flow chart shows only one potential embodiment for how to structure such a system. Many other such system flows may be contemplated.

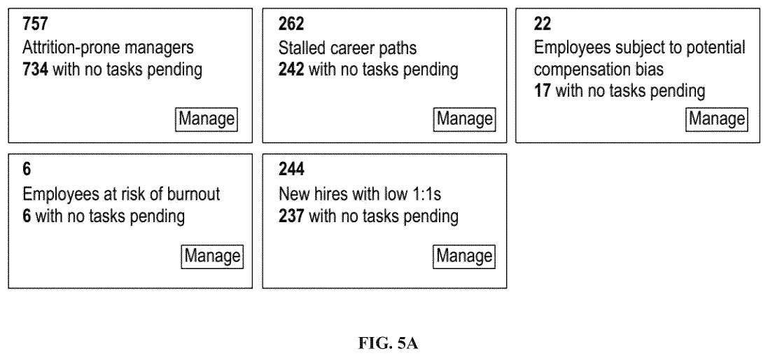

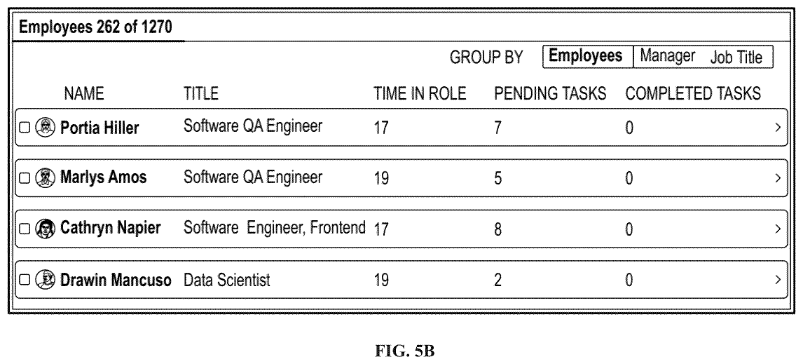

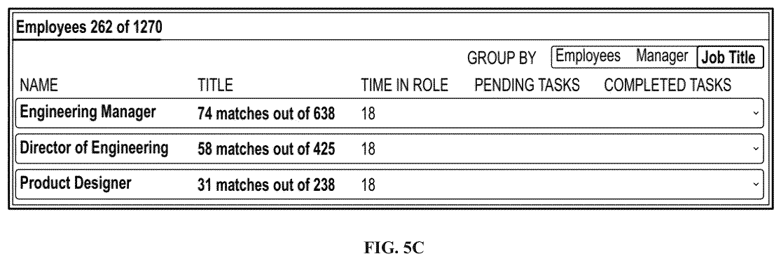

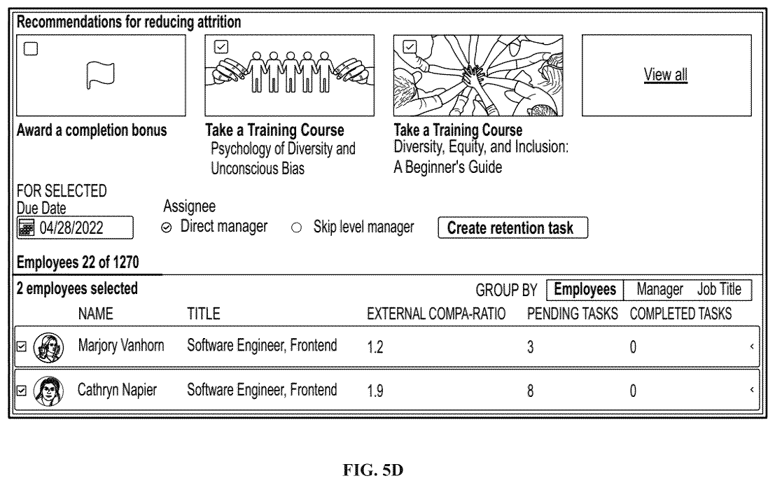

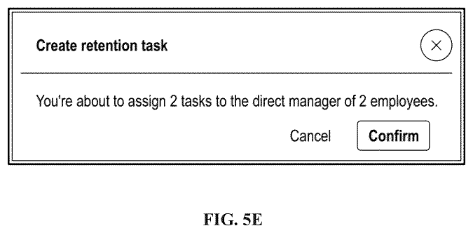

FIG. 5A is a diagram illustrating an example embodiment of a portion of a user interface for selecting a retention path for one or more employees with attrition risk factors, in accordance with some aspects of the systems and methods herein. The user interface shows a user a number of risk factors with associated risk factor values, such as that there are 757 attrition-prone managers, and 734 attrition-prone managers with no tasks pending. A user can choose to manage any of these retention paths as a way to manage attrition risk.

FIG. 5B is a diagram illustrating an example embodiment of a portion of a user interface for reviewing a list of employees with attrition risk factors, in accordance with some aspects of the systems and methods herein. A number of employees may be viewed, each with a presentation of their title or role, the time in the role, the number of pending tasks associated with the employee, and the number of completed tasks the employee has completed over a period of time.

FIG. 5C is a diagram illustrating an example embodiment of a portion of a user interface for reviewing a list of employees with attrition risk factors by job title, in accordance with some aspects of the systems and methods herein. A number of job titles are listed, each with a number of matches within an organization for that particular title and other associated information.

FIG. 5D is a diagram illustrating an example embodiment of a portion of a user interface for making one or more selections from a list of recommended retention tasks, in accordance with some aspects of the systems and methods herein. A number of recommendations for reducing attrition are shown, including awarding a completion bonus, taking a training course on unconscious bias, taking a training course on diversity, equity, and inclusion, and more. The user has checked these two training course recommendations, and a list of employees appears who would benefit from taking the training courses.

FIG. 5E is a diagram illustrating an example embodiment of a portion of a user interface for creating one or more retention tasks for one or more employees with attrition risk factors, in accordance with some aspects of the systems and methods herein. The user interface presents the user with a window for creating a retention task. The window informs the user that they are about to assign 2 tasks to the direct manager of 2 employees, and asks if the user would like to cancel or confirm.

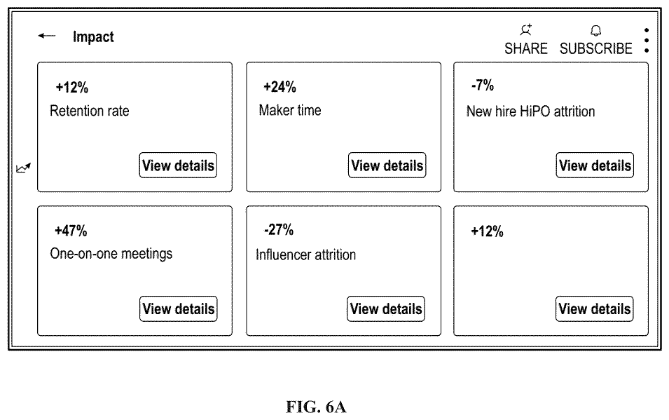

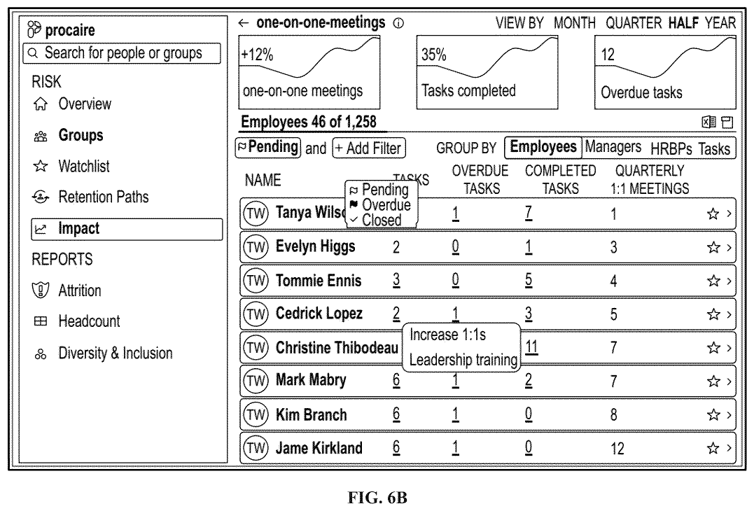

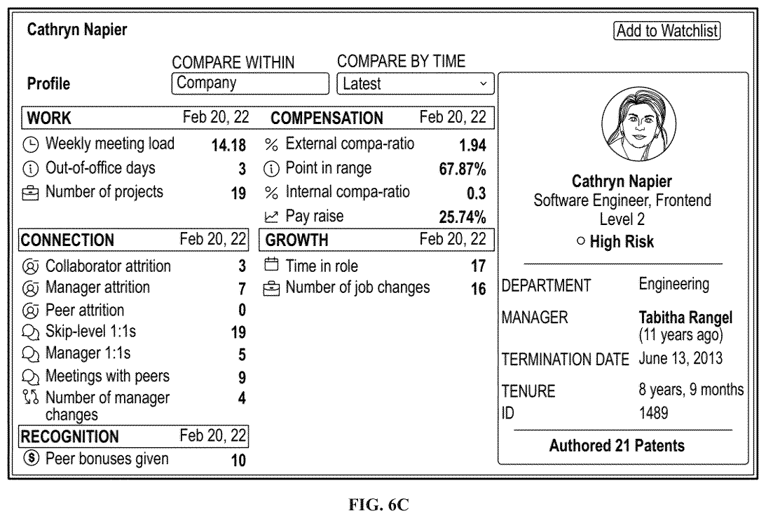

FIG. 6A is a diagram illustrating an example embodiment of a portion of a user interface for tracking analytical data related to retention tasks, in accordance with some aspects of the systems and methods herein. A user interface presents the user with the impact of training course recommendation(s) on an employee, subset of employees, or the organization as a whole, depending on which the user would like to view. In this example, retention rate has gone up by 12%, one-on-one meetings have increased by 47%, and influencer attrition has decreased by 27%.

FIG. 6B is a diagram illustrating an example embodiment of a portion of a user interface for tracking the impact of retention tasks for employees with attrition risk factors, in accordance with some aspects of the systems and methods herein. At a glance, a user can see recommendations for a number of employees. The user has hovered over data for one employee, and seen that there is a recommendation for the employee to increase one-on-one meetings and to take a leadership training course. A number of other pieces of data relevant to attrition are displayed for employees.

FIG. 6C is a diagram illustrating an employee profile with attrition risk factors presented.

In the illustrated example of an employee profile, a single employee and their information relating to attrition risk is presented. Attrition risk factors which have been presented include, e.g., weekly meeting load, out-of-office days taken, number of projects, collaborator attrition, manager attrition, the number of manager 1:1 meetings, the number of manager changes the employee has undergone, external compensation ratio, pay raise increase percentage, time in role, number of job changes, and more. Associated risk factors are also included for these risk factors. For example, manager attrition is one risk factor with an associated risk factor value of 7, an external compensation ratio is another risk factor with an associated risk factor value of 1.94. In the top right, a “compare by time” dropdown menu box allows a user (e.g., a manager of the employee or executive of the company) to select a time frame, such as the state of the employee attrition risk in the “latest” time frame, i.e., the current attrition risk of the employee. Other dropdown box options may be, e.g., “3 months ago”, “1 year ago”, or any other relevant time frame. By using this dropdown menu box to switch between time frames, the user can take note of how attrition risks have changed for the employee over time. For example, a user may note that the number of project issues the employee is associated with has gone up over time, or a user may note that ever since following the training course recommendation to take a course on time management, the number of projects has gone down or the number of manager-level 1:1 meetings has gone up.

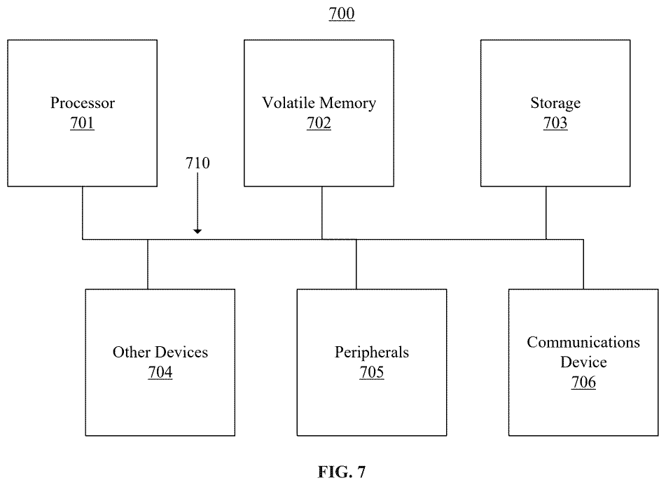

FIG. 7 is a diagram illustrating an exemplary computer that may perform processing in some embodiments. Exemplary computer 700 may perform operations consistent with some embodiments. The architecture of computer 700 is exemplary. Computers can be implemented in a variety of other ways. A wide variety of computers can be used in accordance with the embodiments herein.

Processor 701 may perform computing functions such as running computer programs. The volatile memory 702 may provide temporary storage of data for the processor 701. RAM is one kind of volatile memory. Volatile memory typically requires power to maintain its stored information. Storage 703 provides computer storage for data, instructions, and/or arbitrary information. Non-volatile memory, which can preserve data even when not powered and including disks and flash memory, is an example of storage. Storage 703 may be organized as a file system, database, or in other ways. Data, instructions, and information may be loaded from storage 703 into volatile memory 702 for processing by the processor 701.

The computer 700 may include peripherals 705. Peripherals 705 may include input peripherals such as a keyboard, mouse, trackball, video camera, microphone, and other input devices. Peripherals 705 may also include output devices such as a display. Peripherals 705 may include removable media devices such as CD-R and DVD-R recorders/players. Communications device 706 may connect the computer 100 to an external medium. For example, communications device 706 may take the form of a network adapter that provides communications to a network. A computer 700 may also include a variety of other devices 704. The various components of the computer 700 may be connected by a connection medium 710 such as a bus, crossbar, or network.

While the invention has been particularly shown and described with reference to specific embodiments thereof, it should be understood that changes in the form and details of the disclosed embodiments may be made without departing from the scope of the invention. Although various advantages, aspects, and objects of the present invention have been discussed herein with reference to various embodiments, it will be understood that the scope of the invention should not be limited by reference to such advantages, aspects, and objects. Rather, the scope of the invention should be determined with reference to patent claims.

What is claimed:

1. A method, comprising:
connecting to one or more internal data sources within an enterprise and one or more external data sources outside of the enterprise;
receiving a plurality of internal feed data from the internal data sources and external feed data from the external data sources, the internal feed data relating to one or more employees of the enterprise;
determining, based on at least the internal feed data, a plurality of attrition risk factors for the employees, the attrition risk factors being selected from a prespecified list of potential attrition risk factors;
receiving a plurality of learning management system (LMS) data corresponding to training courses being offered, at least a subset of the LMS data relating to the effectiveness of the training courses;
generating one or more training course recommendations for the employees based on at least the LMS data; and
presenting the training course recommendations to one or more client devices.

2. The method of claim 1, wherein the one or more training course recommendations for the employees are generated by one or more recommendation models comprising at least one of: a machine learning model, and a statistical model.

3. The method of claim 2, wherein an output of the one or more recommendation models comprises an outcome of the training course after a specified period of time.

4. The method of claim 3, wherein the outcome of the training course is used to train one or more new recommendation models.

5. The method of claim 1, further comprising:
generating an attrition probability for at least a subset of the employees based on the determined attrition risk factors of each employee.

6. The method of claim 1, further comprising:
for each determined attrition risk factor, determining an associated risk factor value.

7. The method of claim 6, further comprising:
determining that an employee associated with one of the training course recommendations has attended at least one session of the training course that was recommended;
upon a specified period of time, determining one or more updated risk factor values for the employee; and
generating an effectiveness assessment of the training course for the employee based on comparing the one or more updated risk factor values to the previous one or more risk factor values.

8. The method of claim 1, further comprising:
converting the plurality of internal feed data into normalized feed data within a single format.

9. The method of claim 1, wherein the determining of the attrition risk factors comprises generating a plurality of inferences about the employees from the internal feed data and the external feed data.

10. The method of claim 1, wherein the attrition risk factors are generated via one or more attrition risk assessment models.

11. The method of claim 1, wherein at least a subset of the LMS data relates to how effective the training courses being offered have been with respect to employees who have attended the training courses.

12. The method of claim 1, further comprising:
generating effectiveness assessments for one or more training courses being offered,
wherein the training course recommendations are generated based at least in part on the effectiveness assessments.

13. The method of claim 12, wherein the effectiveness assessments are based at least in part on one or more of: historical data of employees who have attended the training courses, and historical data of non-employees who have attended the training courses.

14. The method of claim 12, further comprising:
updating the LMS data to add the effectiveness assessments of the training courses to the LMS data.

15. A communication system comprising one or more processors configured to perform the operations of:
connecting to one or more internal data sources within an enterprise and one or more external data sources outside of the enterprise;
receiving a plurality of internal feed data from the internal data sources and external feed data from the external data sources, the internal feed data relating to one or more employees of the enterprise;
determining, based on at least the internal feed data, a plurality of attrition risk factors for the employees, the attrition risk factors being selected from a prespecified list of potential attrition risk factors;
receiving a plurality of learning management system (LMS) data corresponding to training courses being offered, at least a subset of the LMS data relating to the effectiveness of the training courses;
generating one or more training course recommendations for the employees based on at least the LMS data; and
presenting the training course recommendations to one or more client devices.

16. The communication system of claim 15, wherein at least one of the training course recommendations is presented to one or more of: an employee associated with the training course recommendation, and a manager of an employee associated with the training course recommendation.

17. The communication system of claim 15, wherein the LMS data comprises one or more training course types for training courses being offered, wherein each of the training course types corresponds to addressing one or more of the potential attrition risk factors.

18. The communication system of claim 15, further comprising:
generating one or more explanations for training course recommendations,
wherein the explanations are presented to the one or more client devices.

19. The communication system of claim 15, wherein at least the training course recommendations are used as training data for generating one or more recommendation models.

20. A non-transitory computer-readable medium comprising:
instructions for connecting to one or more internal data sources within an enterprise and one or more external data sources outside of the enterprise;
instructions for receiving a plurality of internal feed data from the internal data sources and external feed data from the external data sources, the internal feed data relating to one or more employees of the enterprise;
instructions for determining, based on at least the internal feed data, a plurality of attrition risk factors for the employees, the attrition risk factors being selected from a prespecified list of potential attrition risk factors;
instructions for receiving a plurality of learning management system (LMS) data corresponding to training courses being
offered, at least a subset of the LMS data relating to the effectiveness of the training courses;
instructions for generating one or more training course recommendations for the employees based on at least the LMS data; and
instructions for presenting the training course recommendations to one or more client devices.
